(19) United States
(12) Patent Application Publication
(10) Pub. No.: US 2006/0218580 A1
(43) Pub. Date: Sep. 28, 2006

(54) System and method for a acquiring URL coordinated with multimedia programming

(76) Inventor: William Jackson Bushnell, St. Charles, IL (US)

Correspondence Address: Lucent Technologies Inc.;Docket Administrator - Room 3J-219, 101 Crawfords Corner Road, Holmdel, NJ, 07733-3030, US

(21) Appl. No.: 11/086,103

(22) Filed: Mar. 22, 2005

(51) Int. Cl. H04N 5/445

(52) U.S. Cl. 725/37

(57) ABSTRACT

A feature is disclosed whereby a customer is able to request URLs associated with programming they are watching or listening to. Using a wireless communication device (e.g., a wireless phone), computer or remote control, the customer sends a request to a URL request server indicating a desire to acquire a URL associated with content communicated on a specified broadcast media. Depending on the media, the customer may identify a channel/station associated with the request. Responsive to the request, the URL request server queries a content server associated with the specified broadcast media or a web server associated with a specified channel/station to identify specific content associated with the request. The URL request server queries a URL server or performs an independent search to find URL(s) corresponding to the specific content. The URL request server delivers the URL(s) to the wireless communication device or to a specified delivery device in the form of a hypertext link that can be used to quickly access an associated website.

### FIELD OF THE INVENTION

This invention relates generally to the field of multimedia communications and, more particularly, to providing network support for acquiring a URL coordinated with multimedia programming (e.g., television or radio programming) via a wireless communication device or PC.

### BACKGROUND OF THE INVENTION

The Internet is a worldwide network of interconnected computing devices that communicate using a standard protocol known as Internet Protocol (IP). The Internet provides a vehicle for users to access various information and/or services through a myriad of web sites. As is well known, a user can access a web site directly by entering a URL (Uniform Resource Locator) in the address line of their web browser or by simply clicking on a URL if it is specified in a hypertext link. Generally, the URL specifies a unique address that directs the browser how to find a file resource on the Internet. Any file within a website, including for example, the home page, an image file, an application program or Java applet can be specified with a URL. The URL specifies a protocol (e.g., hypertext transfer protocol, http) to be used to access the file resource, a domain name that identifies a specific computer on the Internet and a pathname that specifies the location of the file in that computer. Because Internet technology offers great advantages, there is a continuing need to further develop and expand Internet technology to reach traditional markets and services.

One market in which Internet technology seems under-utilized is the area of multimedia communications including, for example, television and radio service. Consumers today may choose from a wide range of service media for radio and television including traditional over-the-air broadcast media, cable, satellite and streaming IP content (e.g., IPTV). Collectively, and even individually in some cases, these services provide varied and dynamically changing content including, without limitation, several varieties of programs, sports, news, weather, movies, music, public service messages, advertisements and pay-per-view content. Whatever the content, it is likely that one or more associated web sites may exist somewhere on the Internet and a customer may wish to access such site(s) if so inclined to gather further information, access services or the like. Presently, however, there is not a convenient way for customers to identify and quickly access URLs of websites corresponding to the programming they are watching or listening to.

At times, certain programs or advertisements will announce or display a URL during the program or advertisement, but most customers do not have access to their Internet browser while watching TV or listening to the radio and may not wish to be take the time and effort to access their browser and type in the URL. Further, to the extent URLs are communicated to viewers or listeners intrinsically within television or radio broadcasts, the communication is usually very brief and can be overlooked or missed by some customers. Moreover, several programs and advertisements do not announce or display URLs at all, and in such case a customer that is motivated to search for related content on the Internet must access their web browser and a search engine to find associated URL(s).

### SUMMARY OF THE INVENTION

These problems are addressed and a technical advance is achieved in the art by a feature that allows customers to identify and quickly access URLs associated with programming they are watching or listening to using a wireless communication device (e.g., a wireless phone or remote control) or computing device (e.g., personal computer). The feature may be used for a variety of broadcast media including, without limitation, over-the-air broadcast media, cable, satellite and streaming IP content (e.g., IPTV). Advantageously, the customer may acquire the URL for substantially any content at the same time they are watching or listening to the content in the form of a hypertext link that can be used to quickly access an associated website.

In one embodiment, there is provided a method for a customer to access URL(s) corresponding to television programming the customer is watching. Using a mobile phone, PDA or PC, the customer sends a URL request to a URL request server. Responsive to the request, the URL request server queries a set-top box to determine one or more items of content communicated to the customer at a time associated with the request. The URL request server then queries a URL server to identify one or more URLs corresponding to the content. The URL server delivers at least one of the one more URLs to a designated delivery device associated with the customer.

In another embodiment, there is provided an alternative method for a customer to access URL(s) corresponding to television programming the customer is watching. Using a remote control, the customer sends a URL request to a set-top box. Responsive to the request, the set-top box determines one or more items of content communicated to the customer at a time associated with the request. The set-top box sends a message to a URL request server including indicia of the specific content and indicia of the customer. The URL request server queries a URL server to identify one or more URLs corresponding to the content and delivers at least one of the one more URLs to a designated delivery device associated with the customer.

In still another embodiment, there is provided a method for a customer to access URL(s) corresponding to broadcast multimedia content the customer is watching or listening to. Using a mobile phone, PDA or PC, the customer sends a URL request to a URL request server. The request indicates a source of the content. Responsive to the request, the URL request server determines one or more URLs associated with the source at a time associated with the request. The URL server delivers at least one of the one more URLs to a designated delivery device associated with the customer.

### BRIEF DESCRIPTION OF THE DRAWINGS

The foregoing and other advantages of the invention will become apparent upon reading the following detailed description and upon reference to the drawings in which:

FIG. 1 is a block diagram of an exemplary communication system that supports acquisition of a URL coordinated with multimedia programming;

FIG. 2 is a flowchart showing a method for acquiring a URL coordinated with multimedia programming according to an embodiment of the invention;

FIG. 3 is a flowchart showing a method for acquiring a URL coordinated with multimedia programming according to another embodiment of the invention; and

FIG. 4 is a flowchart showing a method for acquiring a URL coordinated with multimedia programming according to yet another embodiment of the invention.

### DESCRIPTION OF THE PREFERRED EMBODIMENT(S)

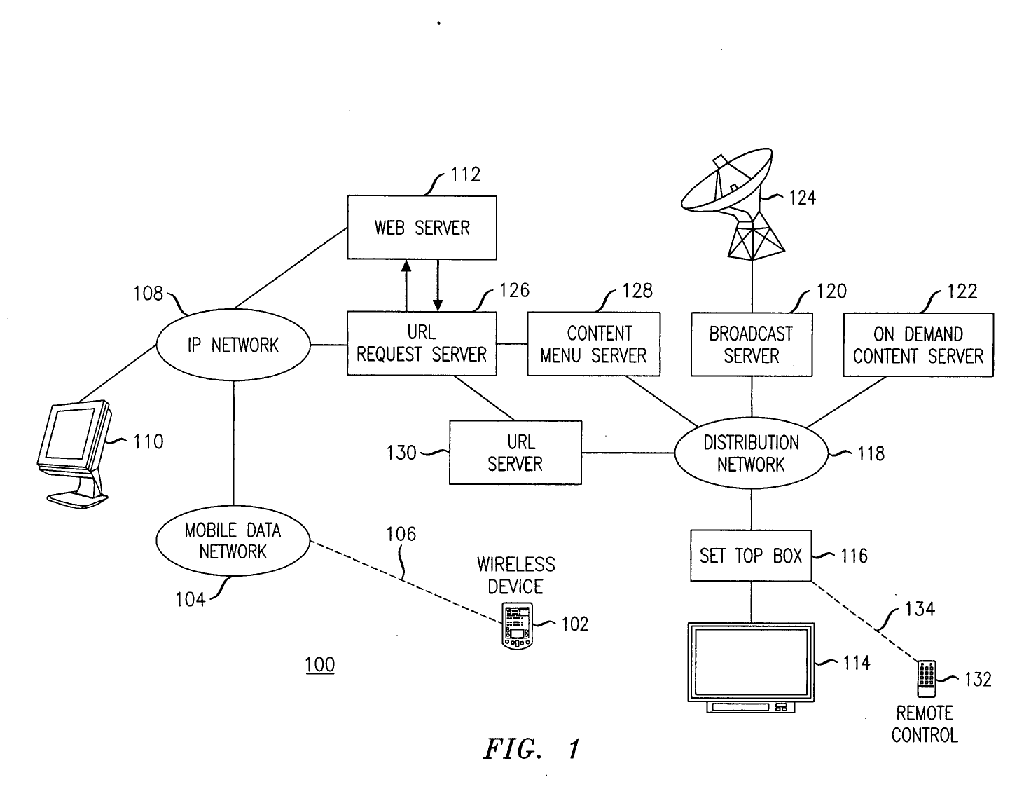

FIG. 1 depicts a communications system 100 that supports acquisition of a URL coordinated with multimedia programming. In various embodiments, the URL may be requested from a wireless communication device, computing device or remote control. A wireless communication device 102 is operably connected to a mobile data network 104 via a radio link 106. The wireless communication device 102 may comprise, without limitation, a mobile phone, laptop computer, personal digital assistant (PDA) or the like. The radio link 106 is a functional link that supports wireless communication between the wireless communication device 102 and mobile data network 104. The radio link 106 may be implemented using air interface technologies including but not limited to, CDMA, TDMA, GSM, UMTS, IEEE 802.11 (e.g., WiFi) and IEEE 802.16 (e.g., WiMAX).

The mobile data network 104, and hence the wireless communication device 102 is operably connected to an IP network 108. The IP network 108 comprises a data network such as, for example, the Internet or a managed IP network. As shown, a computer 110 (e.g., PC) is also connected to the IP network 108. Generally, the wireless communication device 102, computer 110 or any computing device that is connected to the IP network 108 may access a plurality of web servers 112 (one shown). The web servers 112 maintain web sites accessible by the wireless communication device 102 and/or computer 110 via the IP network. The wireless communication device 102 and/or computer 110 may access the web sites by entering a URL in the address line of a web browser, if provided, or by clicking on a URL if it is specified in a hypertext link.

The present invention provides a manner for customers to acquire URLs associated with multimedia programming they are viewing or listening to, as the case may be. For example and without limitation, a customer may acquire URLs associated with over-the-air broadcast media, cable, satellite television or radio or streaming IP content (e.g., IPTV). FIG. 1 illustrates the case where video content is received by a television monitor 114 connected to a set-top box (or receiver) 116, as is the typical arrangement for cable or satellite TV service or IPTV. Also shown is a remote control 132 that wirelessly communicates via link 134 with the set-top box 116. As is well known, the remote control can be operated by a customer to switch channels, order PPV programming, navigate menu screens and the like. The remote control link 134 may be implemented, for example and without limitation, by infrared or short-range wireless (e.g., Bluetooth) technology.

As will be appreciated, customers might also receive video content over-the-air via an antenna (not shown) connected to the television. Similarly, customers might also receive radio content via a radio with antenna (not shown). Further, customers might receive video or radio content via wireless communication device 102 or computer 110.

The set-top box 116 is connected to a distribution network 118 that controls distribution of content to various customers. In the embodiment of FIG. 1, the content originates from a broadcast server 120 and an on-demand content server 122. The broadcast server 120 delivers programming from various television networks each providing content such as programs, sports, news, weather, movies, music, public service messages and advertisements (“commercials”). Typically, the broadcast server 120 receives the network programming via one or more satellite receivers 124. The on-demand content server 122 delivers various “on-demand” content such as pay-per-view movies, programs, sports and the like.

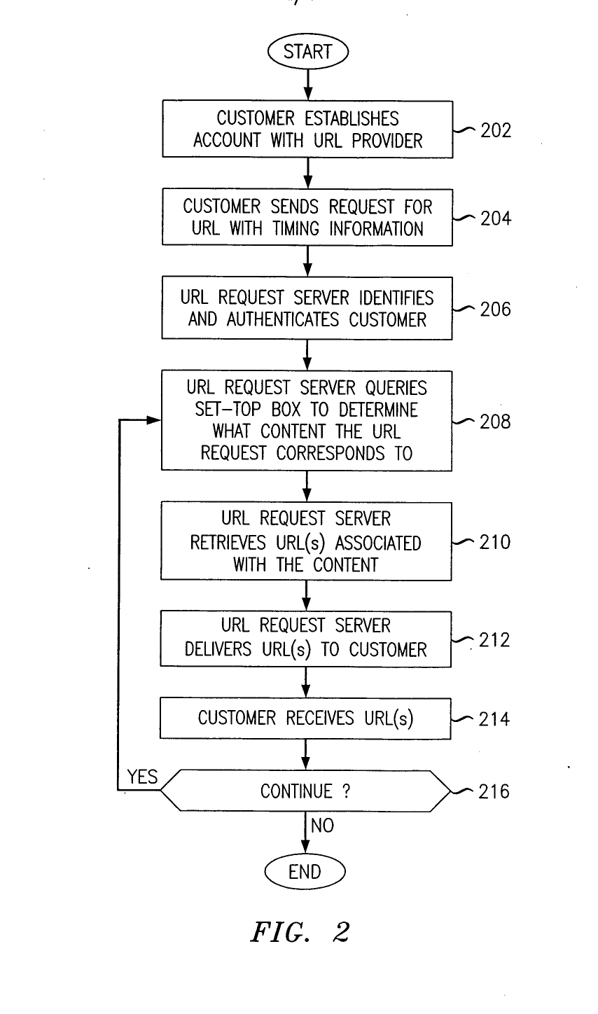

As will be described in greater detail in relation to FIG. 2, a customer can request URLs corresponding to what they are watching (or listening to) by sending a message from wireless communication device 102 to a URL request server 126. The URL request server 126 is operably connected to a Content Menu server 128 and URL server 130. The URL request server 126 includes processor and memory (not shown) for receiving customer requests, communicating messages with the Content menu server 128, URL server 130 and/or set-top box 116 and for communicating independently with various web servers 112.

The Content Menu server 128 is operably connected to the distribution network 118. When a customer wants to watch television, the customer indicates via the set-top box 116 what channel or what video-on-demand content they want to watch. The content menu server receives the request and checks to see if the request is consistent with the customer's subscription. If it is a valid request, the content menu server instructs the broadcast server or the on-demand content server to stream the content to the customer's set-top box. In such manner, the set-top box 116 knows what content the customer is watching.

The URL server 130 captures and stores URLs for the content being delivered. Alternatively or additionally, the URLs may be captured and stored in the set-top box 116. In one embodiment, the URLs are embedded within the video content delivered to the customer; the URLs are selected and embedded in the video file by the broadcast server or on-demand content server when the video file is formatted for delivery to the customer. The URLs may or may not be actually displayed to the customer. That is, the URLs comprise information embedded within the video content but the URL information need not be displayed. Alternatively or additionally, the URL server 130 or set-top box 116 may independently query or search for URLs associated with the video content.

In one embodiment, URLs are displayed to the customer in some manner on the television screen. This may require that the video images be modified to show an icon, text or some image of the URL. The image of URL, if provided, might also have a special font, color scheme, underscore or the like to indicate that there is a hypertext link. In one embodiment, the image of URL is captured by the URL server 130 as the video content is being played to the customer.

In one embodiment, upon receiving a request for URL, the URL request server 126 queries the set-top box 116 to determine what video content the customer is watching, retrieves the corresponding URL(s) from the URL server 130 and returns the URL(s) to the wireless communication device 102 and/or computer 110. In one embodiment, the URL(s) are provided in the form of a hypertext link, such that the customer is able to quickly click on the link to access the corresponding web site. This may be implemented, for example, by including the URL in a WAP Push message sent via SMS to the wireless communication device 102. The wireless communication device includes a WAP client (not shown) operable to read the Push message and accessing the web site corresponding to the URL. When the customer opens the SMS message, the WAP client is initiated to access the web site corresponding to the URL. As another example, the URL can be delivered via Instant Messaging to the computer 110.

In one embodiment, in the case where the customer is watching or listening to broadcast media, the request for URL may specify the type of broadcast media and the station/channel the customer is watching or listening to. In such case, the URL request server queries a web server 112 associated with the indicated radio or television station to find out what content the customer was watching or listening to at the time of request. Thereafter, the URL request server may query the URL server 130 or perform an independent search to find a URL corresponding to the content and return the URL to the customer.

FIG. 2 is a flowchart of a method that may be implemented in a communication system of the type shown in FIG. 1 for a customer to acquire a URL coordinated with multimedia programming. The method presumes at block 202, that the customer subscribes to a URL service, thereby establishing an account with a URL provider that enables the customer to receive and access URLs associated with multimedia programming that the customer is watching or listening to. The URL service may be provided by an independent service provider or by one or more service providers of the multimedia programming.

In one embodiment, the account identifies one or more types of broadcast media from which the customer is eligible to receive URLs. For example, the account may identify one or more of over-the-air radio or television media, cable television, satellite TV or radio or streaming IP media (e.g., IPTV). In one embodiment, the account further includes indicia of the device from which the customer will access the URL service. In one embodiment, the customer requests URLs from the wireless communication device 102 and the account identifies the mobile identification number and/or telephone number of the device 102. Alternatively, the customer might access the URL service from their computer 110, in which case the account identifies the e-mail address or Instant Messaging address of the computer 110. The account may further specify a delivery device that the customer desires to receive the URLs. For example, the customer may indicate that the URLs should be delivered to wireless communication device 102, computer 110 or TV monitor 114. The account may further specify message format(s) (e.g., SMS messages, e-mail) to be used for URL requests and responses.

The service scenario begins when the customer sees (or hears) an item of content for which they want to receive a corresponding URL. At step 204, the customer sends a request for URL corresponding to particular content. The request may be initiated, for example, from the wireless communication device 102 or computer 110 (hereinafter “requesting device”). The content may comprise, for example, programs, sports, news, weather, movies, music, public service messages or advertisements shown on television 114. The content may or may not intrinsically have communicated a URL. The request for URL specifies timing information indicating a time of the request or time window for which the URL is requested.

In one embodiment, for example, the request is a short message service (SMS) message to the URL request server 126 requesting a URL associated with content that is currently playing on television 114. Alternatively, the request may comprise a multimedia message service (MMS) message. The timing information may comprise a current chronological time or “system” time corresponding to time the request was sent by the requesting device or received by the URL request server 126. Alternatively or additionally, the timing information may comprise a time window to look forward or backward for content that was previously played or will be played in the future. The timing information may be automatically embedded in the MMS messages sent from the requesting device or, optionally, may be separately entered by the subscriber.

The request (or alternatively, a separate message) may need to specify a particular broadcast media if the customer is eligible to receive URLs from multiple types of broadcast media; but the request need not specify a particular broadcast media if the broadcast media can be presumed inherent to the customer account. For example, if the customer has signed up for a URL service for both satellite TV and satellite radio, the request may specify satellite TV or radio as appropriate. However, if the customer has signed up for a URL service only for satellite TV, the request can be presumed to be associated with a satellite TV program. If the customer does not specify the media and the media can not be presumed based on customer account information, the URL request server could respond with an SMS message listing various media types and prompting the customer to select the particular media type relevant to the URL request.

The method of FIG. 2 contemplates broadcast media comprising, for example, cable television, satellite TV or radio or streaming IP media (e.g., IPTV), all of which are known to use a set-top 116 or equivalent. The broadcast media delivers content via the set-top box 116, and hence the set-top box can determine the particular station/channel (and hence the content) that the customer was viewing or listening to at a particular time.

At step 206, responsive to receiving the request for URL from the customer, the URL request server 126 identifies and authenticates the customer. In one embodiment, the URL request server uses the SMS sending address to identify the customer and queries a database to determine whether the customer has a valid URL service account.

At step 208, presuming the customer is valid, the URL request server 126 queries the set-top box 116 to determine what specific content the URL request corresponds to. Thus, for example, the URL request server may determine the content that was playing on a specified or presumed media at the time of the request or within a specified time window.

At step 210, having identified the specific content the URL request corresponds to, the URL request server 126 retrieves one or more URLs associated with the specific content. In one embodiment, the URL request server queries the URL server 130 for URL(s) associated with particular content; and the URL server 130 replies with one or more URL(s). As has been described in relation to FIG. 1, the URL server 130 captures and stores URLs for various content being delivered. Upon receiving a query from the URL request server 126 identifying specific content, the URL server 130 searches for URL(s) corresponding to the specific content and sends the URL(s) to the URL request server 126. Alternatively or additionally, the URL request server 126 may query a web server 112 or perform an independent search to find URL(s) corresponding to the content, so as to supplement or replace the need to query the URL server 130.

As will be appreciated, the retrieved URL(s) might correspond directly or indirectly to the specific content; and the URL(s) may correspond to a variety of different types of web sites. For example and without limitation, suppose the content is a Chicago Cubs baseball game. In such case, the retrieved URL(s) might comprise the official site of the Chicago Cubs or their opponent, the official site of major league baseball, sites associated with various players, various news or sports sites that have stories on the Chicago Cubs, various e-commerce sites that sell Chicago Cubs merchandise, ticket brokers, and so forth. As is apparent, virtually any number and type of URL(s) could be retrieved for any particular content. The URL(s) might also be selected differently for different customers based on individual preferences or affinity for certain sites, etc.

At step 212, the URL request server 126 delivers the URL(s) to the customer and at step 214, the customer receives the URL(s). Optionally, the URL(s) may be limited to within a pre-specified number or “filtered” based on customer preferences, so as to avoid flooding the customer with multiple URL(s). In one embodiment, the customer may specify a designated delivery device or delivery options at time of service provisioning or via separate messages. For example, the customer might specify the wireless communication device 102, computer 112 or set-top box 116 (so as to allow for displaying the URL(s) on the television monitor 114) as a designated delivery device; and the customer might specify certain options for delivery such as type of message format, time of delivery or the like. In one embodiment, the URL(s) are provided in the form of a hypertext link that the customer can “click” on to access the URL quickly.

The above-described process can be continued, for example, to retrieve URL(s) associated with content that a customer is viewing or listening to as the content varies or changes. At step 216, a determination is made whether to continue. This determination may be made, for example, coincident to customer preferences selected at time of service provisioning, at the initial URL request or via separate message(s). In response to a positive determination, the process returns to step 208 and the process continues to retrieve further URL(s). In response to a negative determination, the process ends until such time as the customer sends another request.

Because some latency exists in requesting URLs (i.e., the content may have progressed to different content, and hence different corresponding URLs by the time the URL request is received and processed), the content server can return current and previous content, or the URL server can return current and previous URLs as desired.

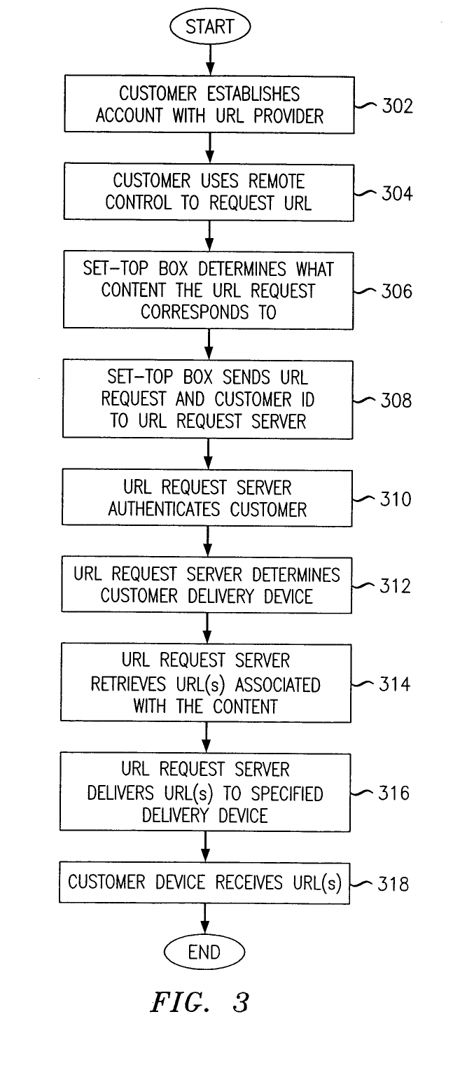

Turning now to FIG. 3, there is shown an alternative method for a customer to acquire a URL coordinated with multimedia programming. At block 302, the customer establishes an account with a URL provider that enables the customer to receive and access URLs associated with multimedia programming. The URL service may be provided by an independent service provider or by one or more service providers of the multimedia programming. The URL service account may identify broadcast media, the device(s) from which the customer will access the URL service, delivery device, message formats and so forth, substantially as described in relation to FIG. 2.

The method of FIG. 3 contemplates that the customer will access the URL service with the remote control 132. At step 304, the customer uses the remote control to request a URL corresponding to particular content shown on the television 114. At step 306, the set-top box 116 determines what content the URL request corresponds to. Thus, for example, the set-top box may determine the content that was playing on the television 114 at the time of the request or within a specified time window.

At step 308, the set-top box sends a URL request to the URL request server. The URL request includes a customer ID or other indicia of the customer and identifies the content corresponding to the request. At step 310, the URL request server 126 authenticates the customer. In one embodiment, the URL request server uses the customer ID to identify the customer and queries a database to determine whether the customer has a valid URL service account.

At step 312, the URL request server determines the customer delivery device. The delivery device may be specified at time of service provisioning or via separate messages. For example, the customer might specify the wireless communication device 102, computer 112 or set-top box 116 as a designated delivery device. The customer might specify certain options for delivery such as type of message format, time of delivery or the like. In one embodiment, the URL(s) are provided in the form of a hypertext link that the customer can “click” on to access the URL quickly.

At step 314, the URL request server 126 retrieves one or more URLs associated with the content. At step 316, the URL request server 126 delivers the URL(s) to the customer delivery device and at step 318, the customer receives the URL(s). As has been described in relation to FIG. 2, the URLs may be obtained from the URL server 130, from a web server 112 or an independent search; and the retrieved URL(s) might correspond directly or indirectly to the specific content.

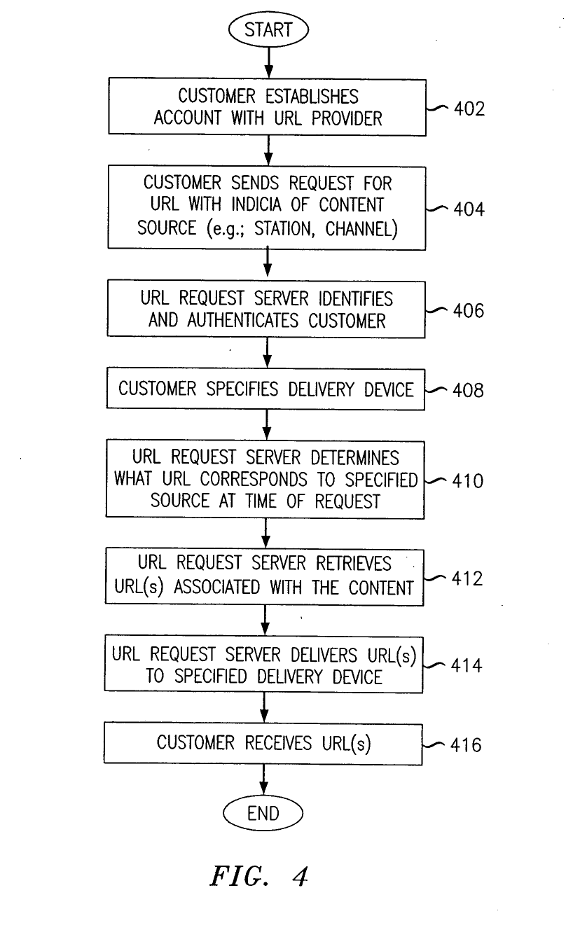

FIG. 4 shows still another alternative method for a customer to acquire a URL coordinated with multimedia programming. At block 402, the customer establishes an account with a URL provider that enables the customer to receive and access URLs associated with multimedia programming. The URL service may be provided by an independent service provider or by one or more service providers of the multimedia programming. The URL service account may identify broadcast media, the device(s) from which the customer will access the URL service, delivery device, message formats and so forth, substantially as described in relation to FIG. 2.

The method of FIG. 4 contemplates that the customer is viewing or listening to over-the-air broadcast media or media for which the URL request server is not able to determine the station/channel the customer is viewing or listening to at a particular time unless so informed by the customer. The media may comprise, for example, broadcast radio or television, or cable television that does not use a set-top box. In one embodiment, if the customer requests a URL associated with such media, the customer specifies the particular station/channel and/or broadcast media.

At step 404, the customer sends a request for URL with indicia of content source (e.g., station/channel information and/or broadcast media) to the URL request server 126. The request may be initiated, for example, from the wireless communication device 102 or computer 110 (hereinafter “requesting device”). In one embodiment, the request further specifies timing information, such as a time of the request or a designated time window as described in relation to FIG. 2.

At step 406, the URL request server 126 identifies and authenticates the customer. At step 408, if not already specified at time of service provisioning, the customer specifies a designated delivery device on which the customer wishes to receive URL(s). At step 410, presuming the customer is valid, the URL request server 126 determines what URL(s) correspond to content that was playing on the specified media at the time of the request or time window.

In one embodiment, based on the indicia of content source, the URL request looks up the IP address or URL for the web server 112 for the specified station/channel and launches a SOAP message to the appropriate web server 112 requesting the specific content played at the time of request. The web server 112 receives the request, looks up a play list, programming menu or the like to find the content at the time of request and sends the information to the URL request server 126. In such manner, the URL request server 126 may determine the specific content that was played at the time of the request or within a designated time window.

At step 412, the URL request server 126 retrieves the URL(s) associated with the content that was playing on the specified media. At step 414, the URL request server 126 delivers the URL(s) to the customer delivery device and at step 416, the customer receives the URL(s). As has been described in relation to FIG. 2, the URLs may be obtained from the URL server 130, from a web server 112 or an independent search; and the retrieved URL(s) might correspond directly or indirectly to the content playing on the specified media.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method for a customer to acquire a URL corresponding to viewed television content, the method comprising:
sending, from a requesting device associated with the customer to a URL request server, a request for URL corresponding to viewed television content; and
responsive to the request, receiving a URL corresponding to the viewed television content from the URL request server.

2. The method of claim 1, wherein the step of sending a request is performed by one of a wireless communication device and computing device.

3. The method of claim 1, wherein the step of receiving a URL comprises receiving a message including a hypertext link to the URL.

4. The method of claim 1, wherein the step of receiving a URL comprises receiving the URL by one of a wireless communication device, computing device and set-top box.

5. In a communication system including a URL request server for providing URL request service for one or more customers, a method comprising the URL request server performing steps of:
receiving, from a requesting device associated with a customer, a request for URL associated with viewed television content;
determining one or more items of specific content communicated to the customer at a time associated with the request;
determining one or more URLs corresponding to the specific content; and
delivering at least one of the one more URLs to a designated delivery device associated with the customer.

6. The method of claim 5, wherein the step of determining specific content comprises querying a set-top box to determine what content was delivered to the customer at a time of the request for URL.

7. The method of claim 5, wherein the step of determining specific content comprises querying a set-top box to determine what content was delivered to the customer within a designated time window.

8. The method of claim 5, wherein the step of determining one or more URLs comprises querying a URL server to determine one or more URLs associated with the specific content.

9. A method for a customer to acquire a URL corresponding to viewed television content, the method comprising:
sending, from a remote control associated with the customer to a set-top box, a request for URL corresponding to viewed television content; and
responsive to the request, receiving a URL corresponding to the viewed television content.

10. The method of claim 9, wherein the step of receiving a URL comprises receiving a message including a hypertext link to the URL.

11. The method of claim 9, wherein the step of receiving a URL comprises receiving the URL by one of a wireless communication device, computing device and set-top box.

12. In a communication system including a set-top box in communication with a URL request server, a method comprising the set-top box performing steps of:
receiving, from a remote control associated with a customer, a request for URL associated with viewed television content;
determining one or more items of specific content communicated to the customer at a time associated with the request;
sending a message to the URL request server including indicia of the specific content and indicia of the customer.

13. In a communication system including a set-top box in communication with a URL request server, a method comprising the URL request server performing steps of:
receiving, from the set-top box, a message including indicia of content communicated to a customer at a designated time;
determining one or more URLs corresponding to the content; and
delivering at least one of the one more URLs to a designated delivery device associated with the customer.

14. The method of claim 13, wherein the step of determining one or more URLs comprises querying a URL server to determine one or more URLs associated with the content.

15. A method for a customer to acquire a URL corresponding to broadcast multimedia content, the method comprising:
sending, from a requesting device associated with the customer to a URL request server, a request for URL indicating a source of the content; and
responsive to the request, receiving a URL corresponding to the broadcast multimedia content from the URL request server.

16. The method of claim 1, wherein the step of sending a request is performed by one of a wireless communication device and computing device.

17. The method of claim 1, wherein the step of receiving a URL comprises receiving a message including a hypertext link to the URL.

18. The method of claim 1, wherein the step of receiving a URL comprises receiving the URL by one of a wireless communication device, computing device and set-top box.

19. In a communication system including a URL request server for providing URL request service for one or more customers, a method comprising the URL request server performing steps of:
receiving, from a requesting device associated with a customer, a request for URL associated with broadcast multimedia content, the request indicating a source of the content;
determining one or more URLs corresponding to the source at a time associated with the request; and
delivering at least one of the one more URLs to a designated delivery device associated with the customer.
